(19) United States
(12) Patent Application Publication
(10) Pub. No.: US 2017/0236092 A1
(43) Pub. Date: Aug. 17, 2017

(54) Cargo Delivery Apparatus And Method

(71) Applicant: Wal-Mart Stores, Inc., Bentonville, AR (US)

(72) Inventors: Donald R. High, Noel, MO (US); Atikhun Unahalekhaka, Boston, MA (US)

(21) Appl. No.: 15/431,873

(22) Filed: Feb. 14, 2017

Related U.S. Application Data
(60) Provisional application No. 62/295,426, filed on Feb. 15, 2016.

(51) Int. Cl. G06Q 10/08; G05D 1/02; G01C 21/34; G05D 1/00

(52) U.S. Cl. CPC G06Q 10/08355; G05D 1/0088; G05D 1/021; G01C 21/34; G05D 2201/0213

(57) ABSTRACT

A control circuit dynamically controls the routing of an autonomous package-delivery terrestrial vehicle configured to simultaneously carry a plurality of packages be variously delivered to a plurality of different address to accommodate a disrupted delivery of at least one of the plurality of packages. The disruption of a delivery can be detected, for example, as a function of a passage of time and/or a message from an intended recipient of at least one of the plurality of packages. Per these teachings, the control circuit can route the vehicle to a different one of the plurality of different addresses to effect delivery of a second one of the plurality of packages followed by routing the vehicle back to the first delivery address to complete the delivery that had been previously disrupted.

### CROSS-REFERENCE TO RELATED APPLICATION

This application claims the benefit of U.S. Provisional Application No. 62/295,426, filed Feb. 15, 2016, which is incorporated herein by reference in its entirety.

### TECHNICAL FIELD

These teachings relate generally to the delivery of cargo.

### BACKGROUND

In a modern retail store environment, there is a need to improve the customer experience and/or convenience for the customer. With increasing competition from non-traditional shopping mechanisms, such as online shopping provided by e-commerce merchants and alternative store formats, it can be important for all retailers (including but not limited to “bricks and mortar” retailers) to focus on improving the overall customer experience and/or convenience.

The foregoing can include providing and/or and enhancing home delivery service. Whether the customer buys a product in a traditional store or via an online opportunity, many customers are seeking the convenience of having their purchases delivered to their homes, offices, hotel rooms, dormitories, or other places of residence or work. Making such a delivery typically entails either enlisting the services of one of the traditional delivery services (such as the United States Postal Service, United Parcel Service, FedEx, and so forth) or of maintaining a private delivery capability. While such options can be useful in some application settings, unfortunately all presently available options leave at least something to be desired by way of cost, timeliness, security, and so forth. Existing delivery paradigms are also particularly ineffective at dealing with real-time disruptions to the delivery schedule.

### BRIEF DESCRIPTION OF THE DRAWINGS

The above needs are at least partially met through provision of the cargo delivery apparatus and method described in the following detailed description, particularly when studied in conjunction with the drawings, wherein:

FIG. 1 comprises a block diagram as configured in accordance with various embodiments of these teachings;

FIG. 2 comprises a block diagram as configured in accordance with various embodiments of these teachings;

FIG. 3 comprises a schematic representation as configured in accordance with various embodiments of these teachings; and

FIG. 4 comprises a flow diagram as configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, these various embodiments employ at least one autonomous package-delivery terrestrial vehicle configured to simultaneously carry a plurality of packages to be variously delivered to a plurality of different address. A control circuit then dynamically controls routing of the autonomous package-delivery terrestrial vehicle to accommodate a disrupted delivery of at least one of the plurality of packages. The disruption of a delivery can be detected, for example, as a function of a passage of time and/or a message from an intended recipient of at least one of the plurality of packages. Per these teachings, the control circuit can route the vehicle to a different one of the plurality of different addresses to effect delivery of a second one of the plurality of packages followed by routing the vehicle back to the first delivery address to complete the delivery that had been previously disrupted.

By one approach, the aforementioned autonomous package-delivery terrestrial vehicle includes a plurality of selectively lockable lockers to hold various ones of the plurality of packages. These lockers can be selectively movable with respect to the vehicle if desired (for example, by rotating the lockers about a shared point rotation) to thereby control selective presentation of a particular one of the lockers to a delivered-package recipient.

So configured, these teachings better facilitate and otherwise improve the use of an autonomous package-delivery terrestrial vehicle to effect the delivery of items ordered by consumers (either from a local retail shopping facility or from an on-line retail shopping service) to their homes, places of business, or otherwise as appropriate.

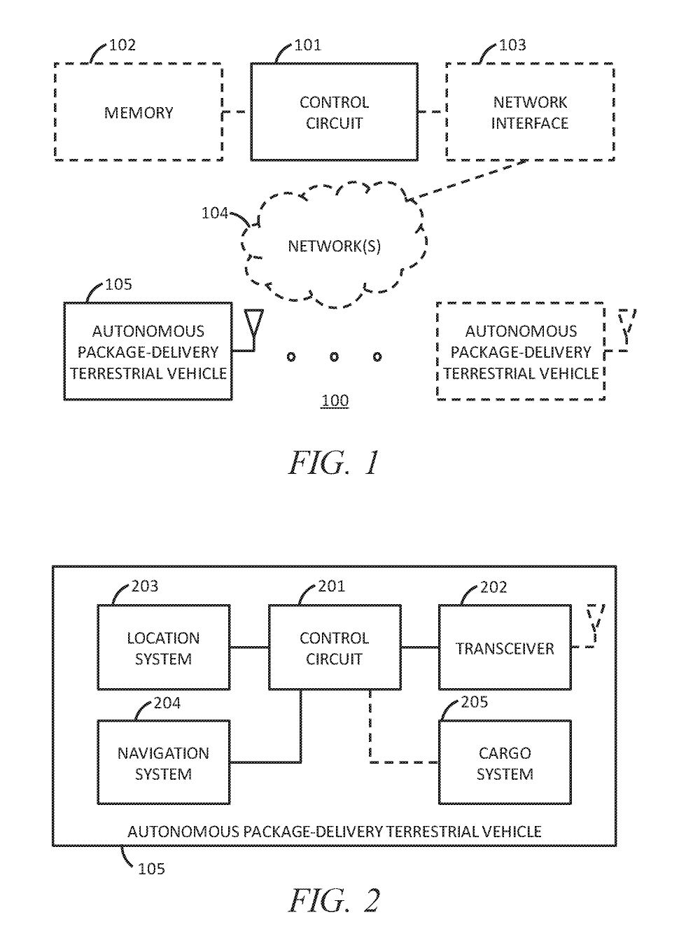

These and other benefits may become clearer upon making a thorough review and study of the following detailed description. Referring now to the drawings, FIG. 1 presents a portion of an illustrative apparatus 100 that accords with these teachings.

In this particular example, the enabling apparatus 100 includes a control circuit 101. Being a “circuit,” the control circuit 101 therefore comprises structure that includes at least one (and typically many) electrically-conductive paths (such as paths comprised of a conductive metal such as copper or silver) that convey electricity in an ordered manner, which path(s) will also typically include corresponding electrical components (both passive (such as resistors and capacitors) and active (such as any of a variety of semiconductor-based devices) as appropriate) to permit the circuit to effect the control aspect of these teachings.

Such a control circuit 101 can comprise a fixed-purpose hard-wired hardware platform (including but not limited to an application-specific integrated circuit (ASIC) (which is an integrated circuit that is customized by design for a particular use, rather than intended for general-purpose use), a field-programmable gate array (FPGA), and the like) or can comprise a partially or wholly-programmable hardware platform (including but not limited to microcontrollers, microprocessors, and the like). These architectural options for such structures are well known and understood in the art and require no further description here. This control circuit 101 is configured (for example, by using corresponding programming as will be well understood by those skilled in the art) to carry out one or more of the steps, actions, and/or functions described herein.

By one optional approach the control circuit 101 operably couples to a memory 102. This memory 102 may be integral to the control circuit 101 or can be physically discrete (in whole or in part) from the control circuit 101 as desired. This memory 102 can also be local with respect to the control circuit 101 (where, for example, both share a common circuit board, chassis, power supply, and/or housing) or can be partially or wholly remote with respect to the control circuit 101 (where, for example, the memory 102 is physically located in another facility, metropolitan area, or even country as compared to the control circuit 101).

In addition to other information that can be pertinent to carrying out the various activities described herein (such as, for example, information regarding scheduled deliveries (including scheduled delivery windows), map and routing information, and so forth), this memory 102 can serve, for example, to non-transitorily store the computer instructions that, when executed by the control circuit 101, cause the control circuit 101 to behave as described herein. (As used herein, this reference to “non-transitorily” will be understood to refer to a non-ephemeral state for the stored contents (and hence excludes when the stored contents merely constitute signals or waves) rather than volatility of the storage media itself and hence includes both non-volatile memory (such as read-only memory (ROM) as well as volatile memory (such as an erasable programmable read-only memory (EPROM).)

This figure also illustrates that the control circuit 101 and also optionally operably couple to a network interface 103. So configured the control circuit 101 can communicate with other elements (both within the apparatus 100 and external thereto) via the network interface 103. This network interface 103 can communicatively couple to one or more intervening networks 104 (such as, but not limited to, the Internet and any of a variety of wireless data and telephony networks) as desired. Network interfaces, including both wireless and non-wireless platforms, are well understood in the art and require no particular elaboration here.

The enabling apparatus 100 also includes at least one (and likely a plurality of) autonomous package-delivery terrestrial vehicle 105. As used herein, the expression “autonomous” will be understood to refer to the ability of the vehicle to drive on public roads between its delivery destinations without an in-vehicle human pilot or a remote human pilot. The expression “terrestrial,” in turn, will be understood to refer to the ordinary mode of locomotion employed by the vehicle; i.e., that the vehicle travels while in physical contact with the ground rather than while moving through the air above the ground without contacting the ground.

FIG. 2 provides an illustrative example of an autonomous package-delivery terrestrial vehicle 105. It shall be understood that the specific details of this example are not intended to suggest any particular limitations in these regards.

The autonomous package-delivery terrestrial vehicle 105 in this example includes a control circuit 201 that is physically similar to the control circuit 101 described above. In fact, if desired, the control circuit 201 contained in the autonomous package-delivery terrestrial vehicle 105 may comprise, in whole or in part, the aforementioned control circuit 101.

In this example this control circuit 201 operably couples to a transceiver 202 that is configured to wirelessly communicate compatibly with, for example, one or more of the aforementioned networks 104. The control circuit 201 also operably couples to a location system 203 (configured to determine a present location of the autonomous package-delivery terrestrial vehicle 105) such as a global positioning system (GPS) component. In this example the control circuit 201 also further operably couples to a navigation system 204 configured to the steering and locomotion components of the autonomous package-delivery terrestrial vehicle 105 to thereby control movement of the autonomous package-delivery vehicle 105 as the latter travels from one destination to another. These and other typical components of an autonomous terrestrial vehicle are known in the art. As the present teachings are not overly sensitive to any particular choices in these regards, further elaboration is not provided here as regards such components for the sake of brevity.

The autonomous package-delivery terrestrial vehicle 105 also includes a cargo system 205. This cargo system 205 may simply comprise an open cargo-receiving area such as an automobile trunk, the bed of a pickup truck, or the interior storage area of a van. By another approach, however, the cargo system 205 may comprise a plurality of selectively lockable lockers. These lockers can hold various ones of the plurality of packages that are to be delivered to the various addresses. For example, a first such a locker can contain one item to be delivered to a first address while a second such locker contains two other items to be delivered to a second address. These lockers can all have an identical size or can be differently sized as desired.

By one approach the lockers can be selectively locked using an electronically-controlled locking mechanism. By one approach the control circuit 201 for the autonomous package-delivery terrestrial vehicle 105 controls that electronically-controlled locking mechanism (in response, for example, to authenticating a package recipient upon receiving a code, a particular voiced command, and so forth). By another approach the locker includes its own self-contained capability to control the electronically-controlled locking mechanism. For example, each locker may include a keypad that a recipient uses to enter an unlocking code. Upon entering the correct unlocking code the locker can unlock its own door to provide the recipient with access to the interior of the locker.

By one approach at least some of the plurality of selectively lockable lockers can be selectively movable with respect to the autonomous package-delivery terrestrial vehicle 105 (without also physically releasing the locker and/or otherwise permitting the locker to be removed from the autonomous package-delivery terrestrial vehicle 105). In this case the control circuit 201 may, for example, selectively and automatically control which of the lockers is presented to a delivered-package recipient at a particular delivery address.

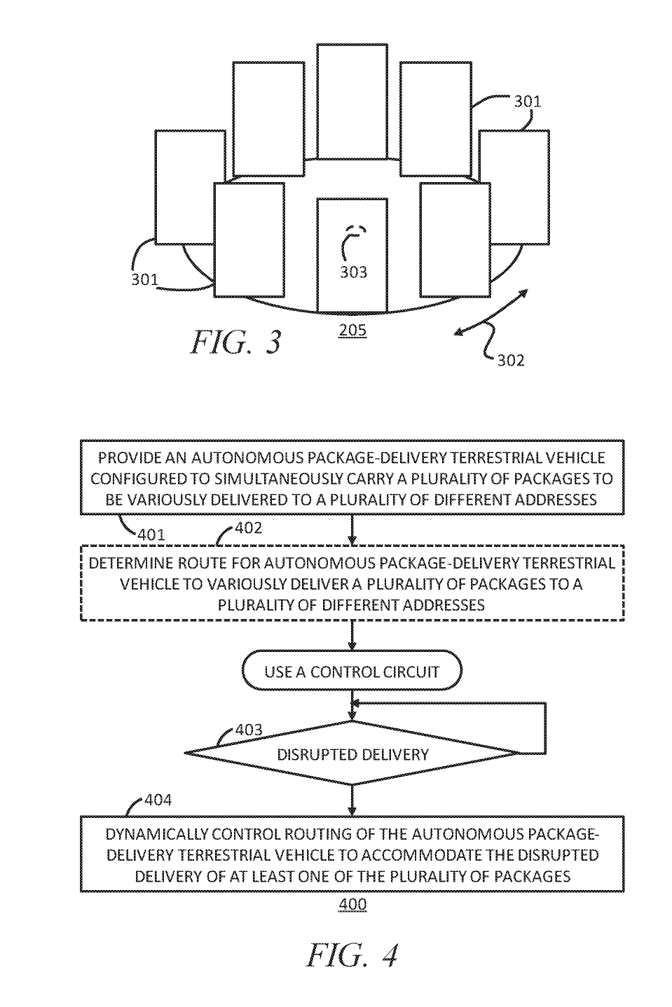

Referring momentarily to FIG. 3, by one approach these selectively lockable lockers 301 are configured to rotate 302 about a shared point of rotation 303. So configured, the control circuit 201 can cause the lockers 301 to selectively rotate about that shared point of rotation 300 and thereby present a particular one of the lockers 301 to a particular delivery recipient.

Referring now to FIG. 4, a process 400 that can be compatibly carried out with the foregoing apparatus 100 will be described. At block 401 this process 400 provides one or more of the above-described autonomous package-delivery terrestrial vehicles 105. In a typical application setting this autonomous package-delivery terrestrial vehicle 105 will be carrying a plurality of packages that are to be variously delivered to a plurality of different address; in other words, at least one of the packages being carried is to be delivered to one delivery address while at least another one of the packages being carried is to be delivered to another, different address.

At optional block 402 this process 400 provides for determining a route for the autonomous package-delivery terrestrial vehicle 105 to use when delivering the aforementioned plurality of packages to the aforementioned plurality of different addresses. Various approaches are known in the art to derive such a route. By one approach, for example, a human being may determine the route. By another approach, the route may be automatically determined by a computational platform. As these various approaches and methodologies are known in the art, further elaboration is not provided here regarding this activity.

In this illustrative example the remaining steps of the process 400 are carried out by the aforementioned control circuit 101. In particular, at decision block 403 the control circuit 101 detects a disrupted delivery of at least one of the aforementioned packages. In particular, these teachings will accommodate detecting a disrupted delivery of a package to a delivery address for that package while the autonomous package-delivery terrestrial vehicle 105 is en route to the delivery address with that package.

This detection can be based, for example, upon a passage of time. For example, the autonomous package-delivery terrestrial vehicle 105 may report to the control circuit 101 when a particular package has been delivered to a particular delivery address. When such a report for a given package fails to arrive and a predetermined delivery window has now expired for that delivery address, this state of affairs can be used by the control circuit 101 as an indication of a disrupted delivery.

As another example in these regards the control circuit 101 may base the detection of a disrupted delivery upon a message from an intended recipient of the package in question. For example, the recipient may transmit a message (via an online capability, a smart phone app, a text message, and so forth as desired) to indicate their unavailability to receive a package at a particular time notwithstanding previously agreed-to scheduling. As one simple illustration in these regards, a delivery recipient may have a doctor's appointment that is running late and hence their arrival at their home will be delayed by 30 minutes. Receiving information in these regards can be used by the control circuit 101 to detect a corresponding disrupted delivery.

Upon detecting a disrupted delivery, and as illustrated at block 404, the control circuit can automatically respond by dynamically controlling (i.e., changing) the routing of the autonomous package-delivery terrestrial vehicle 105 to accommodate that disrupted delivery. As used herein, the word “dynamically” shall be understood to mean in an active and ongoing manner. “Ongoing” does not mean that the activity must be temporally seamless, uninterrupted, and continuous, but rather that the activity is readily undertaken in a responsive manner at times of need.

For example, the control circuit 101 can reroute the autonomous package-delivery terrestrial vehicle 105 to a different one of the plurality of addresses to effect delivery of a second, different one of the plurality of packages to that different address. That rerouting can further include later routing the autonomous package-delivery terrestrial vehicle 105 back to the disrupted delivery address to effect delivery of that first package. That rerouting back to the disrupted delivery address may immediately follow delivery of the second package or may follow any number of other intervening package deliveries as appropriate to the application setting.

So configured, these teachings permit the use of an autonomous delivery vehicle in application settings where disruptions to a delivery plan that includes multiple destinations/stops are likely. In particular, completion of at least most if not all scheduled deliveries can be accommodated in a manner that can at least closely accord with an original schedule.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

What is claimed is:

1. An apparatus comprising:
an autonomous package-delivery terrestrial vehicle configured to simultaneously carry a plurality of packages to be variously delivered to a plurality of different addresses;
a control circuit configured to dynamically control routing of the autonomous package-delivery terrestrial vehicle to accommodate a disrupted delivery of at least one of the plurality of packages.

2. The apparatus of claim 1 wherein the control circuit is contained in part, but not entirely, in the autonomous package-delivery terrestrial vehicle.

3. The apparatus of claim 1 wherein the control circuit is configured to detect the disrupted delivery of the at least one of the plurality of packages.

4. The apparatus of claim 1 wherein the control circuit is configured to detect the disrupted delivery as a function, at least in part, of at least one of:
a passage of time;
a message from an intended recipient of the at least one of the plurality of packages.

5. The apparatus of claim 1 wherein the control circuit is configured to dynamically control routing of the autonomous package-delivery terrestrial vehicle in response to detecting a disrupted delivery of a first one of the plurality of packages while en route to a first delivery address for the first one of the plurality of packages.

6. The apparatus of claim 5 wherein the control circuit is configured to dynamically control routing of the autonomous package-delivery terrestrial vehicle in response to detecting the disrupted delivery of the first one of the plurality of packages while en route to the first delivery address by rerouting the autonomous package-delivery terrestrial vehicle to a different one of the plurality of different addresses to effect delivery of a second one of the plurality of packages followed by routing the autonomous package-delivery terrestrial vehicle to the first delivery address to effect delivery of the first one of the plurality of packages.

7. The apparatus of claim 1 wherein the autonomous package-delivery terrestrial vehicle includes a plurality of selectively lockable lockers to hold various ones of the plurality of packages.

8. The apparatus of claim 7 wherein at least some of the plurality of selectively lockable lockers are selectively movable with respect to the autonomous package-delivery terrestrial vehicle to control which of the plurality of selectively lockable lockers is presented to a delivered-package recipient.

9. The apparatus of claim 8 wherein the selectively lockable lockers that are selectively movable with respect to the autonomous package-delivery terrestrial vehicle are configured to rotate about a shared point of rotation.

10. The apparatus of claim 8 wherein the selectively lockable lockers that are selectively movable with respect to the autonomous package-delivery terrestrial vehicle are configured to move automatically with respect to the autonomous package-delivery terrestrial vehicle.

11. A method comprising:
providing an autonomous package-delivery terrestrial vehicle configured to simultaneously carry a plurality of packages to be variously delivered to a plurality of different addresses;
using a control circuit to dynamically control routing of the autonomous package-delivery terrestrial vehicle to accommodate a disrupted delivery of at least one of the plurality of packages.

12. The method of claim 11 wherein the control circuit is contained in part, but not entirely, in the autonomous package-delivery terrestrial vehicle.

13. The method of claim 11 further comprising:
using the control circuit to detect the disrupted delivery of the at least one of the plurality of packages.

14. The method of claim 13 wherein using the control circuit to detect the disrupted delivery of the at least one of the plurality of packages comprises using the control circuit to detect the disrupted delivery as a function, at least in part, of at least one of:
a passage of time;
a message from an intended recipient of the at least one of the plurality of packages.

15. The method of claim 11 wherein using a control circuit to dynamically control routing of the autonomous package-delivery terrestrial vehicle to accommodate a disrupted delivery of at least one of the plurality of packages comprises using the control circuit to dynamically control routing of the autonomous package-delivery terrestrial vehicle in response to detecting a disrupted delivery of a first one of the plurality of packages while en route to a first delivery address for the first one of the plurality of packages.

16. The method of claim 15 wherein using the control circuit to dynamically control routing of the autonomous package-delivery terrestrial vehicle in response to detecting the disrupted delivery of the first one of the plurality of packages while en route to the first delivery address comprises rerouting the autonomous package-delivery terrestrial vehicle to a different one of the plurality of different addresses to effect delivery of a second one of the plurality of packages followed by routing the autonomous package-delivery terrestrial vehicle to the first delivery address to effect delivery of the first one of the plurality of packages.

17. The method of claim 11 wherein the autonomous package-delivery terrestrial vehicle includes a plurality of selectively lockable lockers to hold various ones of the plurality of packages.

18. The method of claim 17 further comprising selectively moving at least some of the plurality of selectively lockable lockers with respect to the autonomous package-delivery terrestrial vehicle to control which of the plurality of selectively lockable lockers is presented to a delivered-package recipient.

19. The method of claim 18 wherein selectively moving at least some of the plurality of selectively lockable lockers with respect to the autonomous package-delivery terrestrial vehicle comprises rotating the at least some of the plurality of selectively lockable lockers around a shared point of rotation.

20. The method of claim 18 wherein selectively moving at least some of the plurality of selectively lockable lockers with respect to the autonomous package-delivery terrestrial vehicle comprises automatically selectively moving the at least some of the plurality of selectively lockable lockers with respect to the autonomous package-delivery terrestrial vehicle.
